(19) United States
(12) Patent Application Publication
(10) Pub. No.: US 2022/0205585 A1
(43) Pub. Date: Jun. 30, 2022

(54) SUPPORT FRAME WITH ADJUSTABLE ELEVATION ANGLE

(71) Applicants: SOLUTION EXPERT 33 INTERNATIONAL CO., LTD. TAIWAN BRANCH (B.V.I.), NEW TAIPEI CITY (TW); SENSEAGE CO., LTD., TAIPEI CITY (TW); DONGGUAN SOLUTION 33 ELECTRONIC TECHNOLOGY CO., LTD., Dongguan City (CN); SOLUTION EXPERT 33 INTERNATIONAL CO., LTD., Dongguan City (CN)

(72) Inventor: Ben-Tien LIN, New Taipei City (TW)

(21) Appl. No.: 17/156,528

(22) Filed: Jan. 23, 2021

(30) Foreign Application Priority Data
Dec. 25, 2020 (CN) 202023174180.5

(51) Int. Cl. F16M 11/38

(52) U.S. Cl. CPC F16M 11/38; F16M 2200/08

(57) ABSTRACT

This disclosure relates to a support frame with an adjustable elevation angle, which includes a plate body, a positioning part, a first supporting piece, and a second supporting piece. The plate body has a plurality of positioning locations. The positioning part is moveably connected and positioned with one of the positioning locations. The first supporting piece is connected to the plate body. The second supporting piece is connected between the first supporting piece and the positioning part. The positioning part is connected and positioned with one of the positioning locations according to a predetermined elevation angle. The first supporting piece supports between the plate body and the second supporting piece. The second supporting piece supports between the first supporting piece and the positioning part. Therefore, the elevation angle may freely be adjusted according to user's needs.

### BACKGROUND OF THE INVENTION

### Field of the Invention

This disclosure relates to a support frame for an electronic product and in particular relates to a support frame with an adjustable elevation angle.

### Description of Related Art

A support frame is used to support the electronic product for the user in which the electronic product can be the smart mobile phone or the tablet.

The related-art support frame is used to support the electronic product with an elevation angle. However, the elevation angle is fixed and cannot be adjusted according to the various use modes of the electronic product. As a result, the related-art support frame is only proper for a certain use mode and the user's hands are still required in the other use modes. Consequently, the user's hands become strained, which has been criticized for a long time. The above-mentioned use modes include watching videos, playing mobile games, reading information, browsing web pages, and typing. The desired elevation angle of the electronic product differs for different use modes.

### SUMMARY OF THE INVENTION

The objective of this disclosure is to provide a support frame with an adjustable elevation angle.

In order to achieve the above objective, this disclosure provides a support frame with an adjustable elevation angle, which includes a plate body, a positioning part, a first supporting piece, and a second supporting piece. The plate body has a plurality of positioning locations. The positioning part is moveably connected and positioned with one of the positioning locations. The first supporting piece is connected to the plate body. The second supporting piece is connected between the first supporting piece and the positioning part. The positioning part is connected and positioned with one of the positioning locations according to a predetermined elevation angle. The first supporting piece supports between the plate body and the second supporting piece. The second supporting piece supports between the first supporting piece and the positioning part.

Compared with the related are, this disclosure has the following effects. The elevation angle of the electronic product may be freely adjusted according to user's needs such that the electronic product may be supported and used in different use modes by the adjustment of the elevation angle.

### BRIEF DESCRIPTION OF DRAWINGS

FIG. 1 is a front perspective view of the support frame according to the first embodiment of this disclosure;

FIG. 2 is a rear perspective view of the support frame according to the first embodiment of this disclosure;

FIG. 3 is a rear perspective schematic view of the support frame according to the first embodiment of this disclosure;

FIG. 4 is a perspective view of the support frame according to the first embodiment of this disclosure with an adjusted elevation angle;

FIG. 5 is a perspective view of the support frame according to the first embodiment of this disclosure, supporting an electronic product;

FIG. 6 is a perspective view of the support frame according to the second embodiment of this disclosure; and

FIG. 7 is a perspective view of the support frame according to the second embodiment of this disclosure, supporting two electronic products.

### DETAILED DESCRIPTION OF THE INVENTION

The detailed description and technical details of this disclosure are explained below with reference to accompanying figures. However, the accompanying figures are for reference and explanation only, but not to limit the scope of this disclosure.

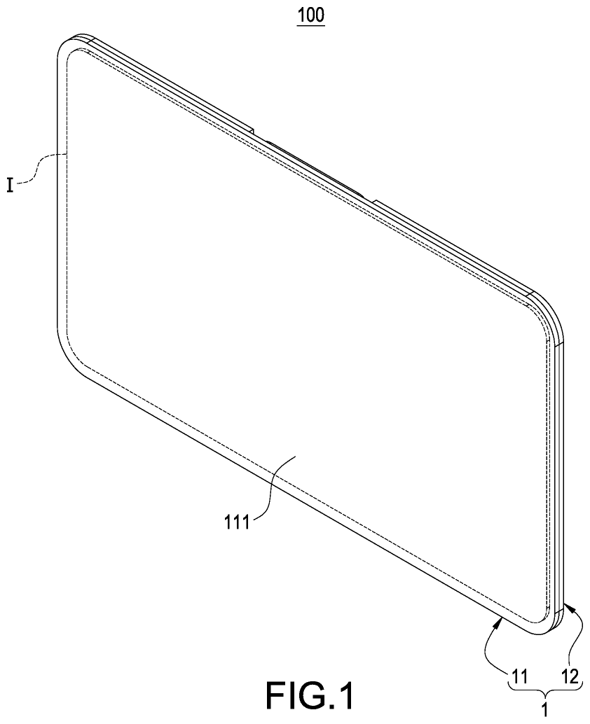

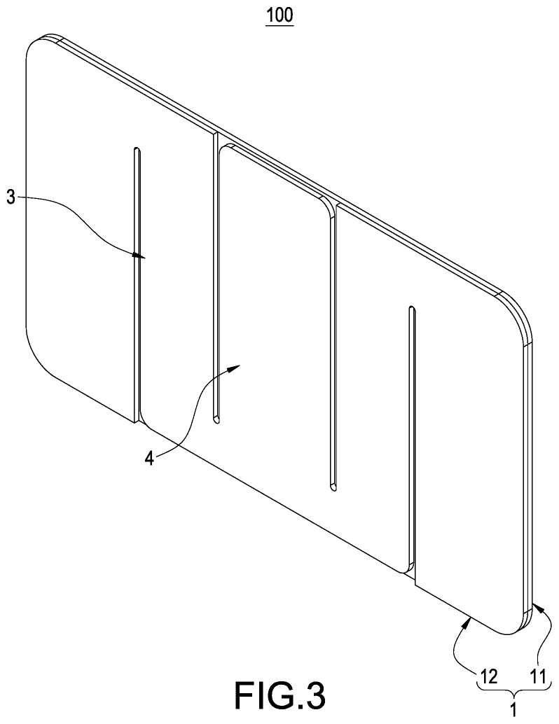

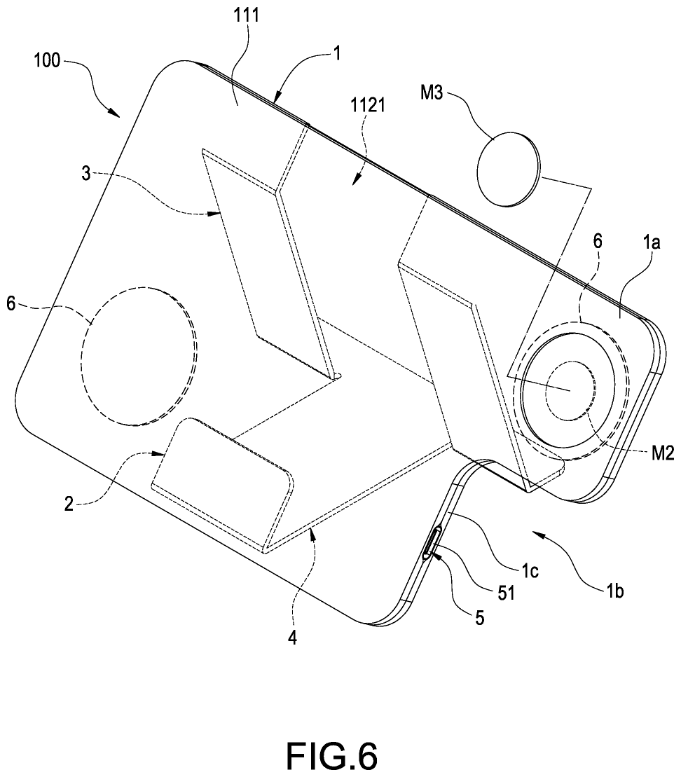

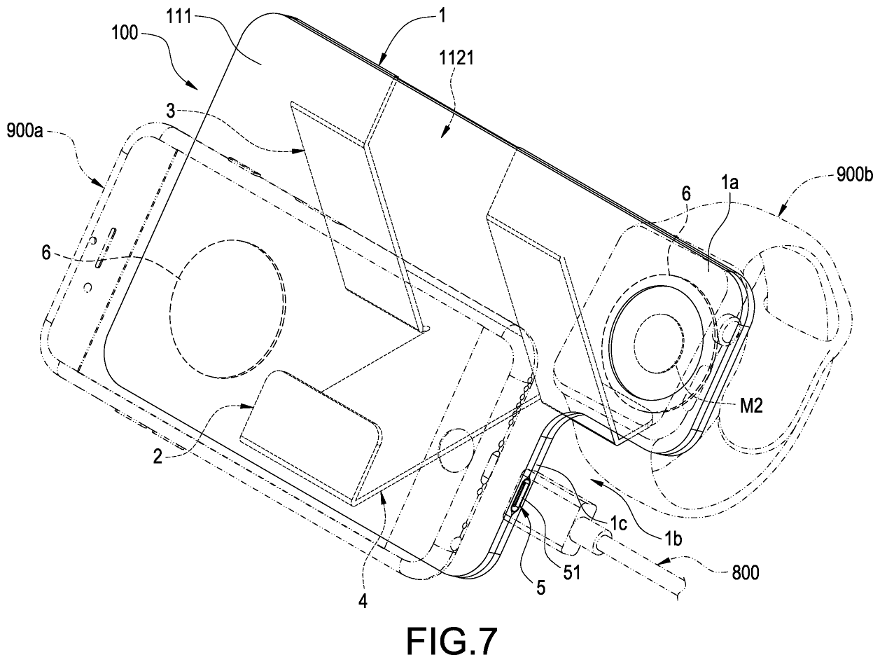

As shown in FIG. 1, this disclosure provides a support frame with an adjustable elevation angle (hereinafter simply referred to the support frame 100), which is used to support at least one electronic product according to a desired elevation angle. FIG. 1 to FIG. 5 show the first embodiment of this disclosure. FIG. 6 and FIG. 7 show the second embodiment of this disclosure.

As shown in FIG. 1 to FIG. 4, the support frame 100 of the first embodiment of this disclosure includes a plate body 1, a positioning part 2, a first supporting piece 3, and a second supporting piece 4.

The plate body 1 may be a single-piece plate body (not shown in figures) or a multi-piece plate body (shown in figures) that includes a first plate 11 and a second plate 12. The first plate 11 and the second plate 12 may be connected to each other in various practical ways. In this embodiment, the first plate 11 and the second plate 12 are stacked and fixed with each other as an example for explanation.

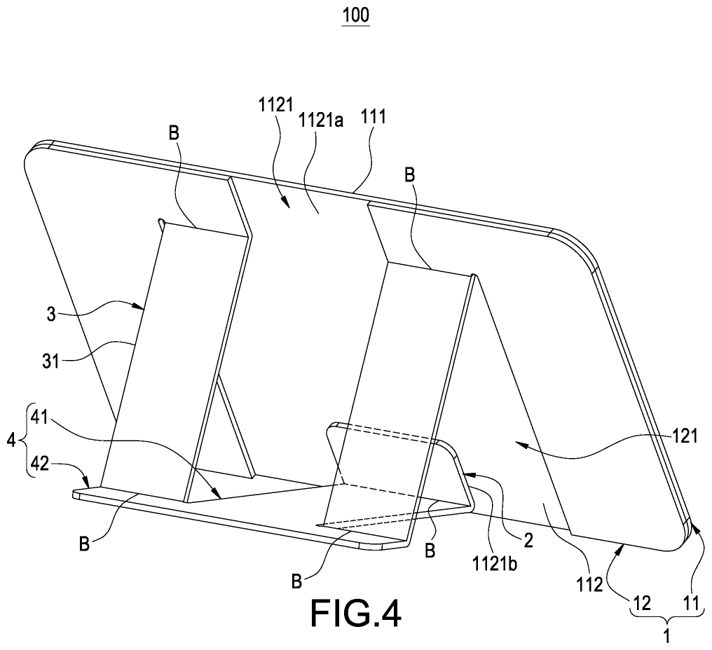

The first plate 11 has a front side 111 and a back side 112 opposite to each other (referring to FIG. 4). One side of the second plate 12 is stacked on and fixed to the back side 112 of the first plate 11. The second plate 12 is provided with an opening 121. A positioning region 1121 is formed on the first plate 11 corresponding to the opening 121 in various feasible ways such that the positioning region 1121 is exposed through the opening 121.

The forming method of the positioning region 1121 in this disclosure is not limited. For example, a plurality of clip fasteners (not shown in figures) may be disposed on the back side 112 or a plurality of magnet parts (not shown in figures) may be embedded in the first plate 11. In some embodiments, both of the magnet parts and the magnet-attractable parts may be embedded. In this embodiment, a magnet-attractable part (referring to FIG. 1) embedded in the first plate 11 is used as an example for explanation. That is, a plurality of positioning locations which are used to be magnetically attracted are formed in the positioning region 1121 of the first plate 11 as shown in FIG. 4. These positioning locations include an initial positioning location 1121a, a final positioning location 1121b, and other positioning locations (not labeled in figures) located between the initial positioning location 1121a and the final positioning location 1121b.

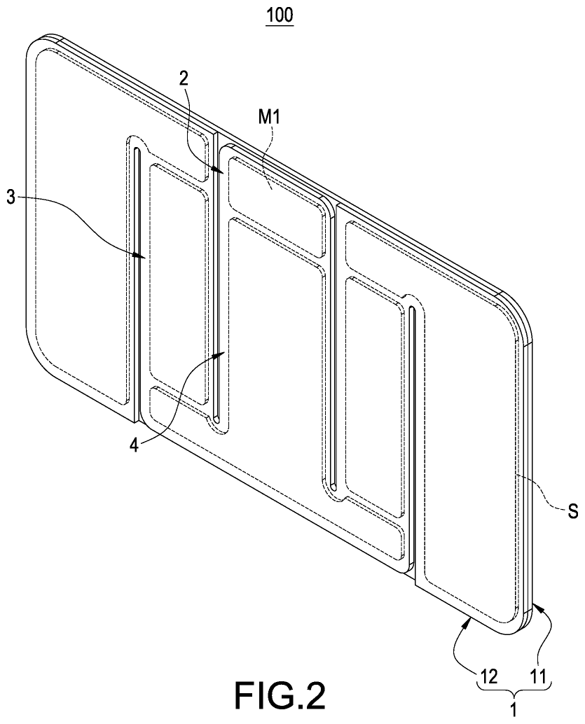

The positioning part 2 is used for the user to moveably select one of the above-mentioned positioning locations for mutual connection and positioning. The positioning method of the positioning part 2 is not limited in this disclosure. For example, a pair of corresponding clip fasteners (not shown in figures) may be disposed on the positioning part 2 such that the positioning part 2 and any one of the above-mentioned clip fasteners may be snapped with each other to be positioned, or a magnet-attractable part (not shown in figures) may be embedded in the positioning part 2 such that the positioning part 2 and any one of the above-mentioned magnetic parts may be attracted with each other to be positioned. In this embodiment, the positioning part 2 embedded with a magnet part M1 (referring to FIG. 2) is used as an example for explanation, in which the positioning part 2 may be attracted with any of the above-mentioned positioning locations to be positioned through the opening 121.

It must be noted that the positioning part 2 may be in a sheet form and slidably attached with the back side 112 of the first plate 11. The positioning part 2 may be magnetically attracted to any one of the positioning locations in a manner of attachment and sliding. Moreover, as shown in FIG. 2, the rest of the second supporting piece 4 and the second plate 12 and the first supporting piece 3 may all be embedded with at least one inner pad S.

The connection method among the body plate 1, the positioning part 2, the first supporting piece 3, and the second supporting piece 4 are not limited in this disclosure and the connection method described below is used as an example in this embodiment. As shown in FIG. 4, one end of the first supporting piece 3 is foldably connected to the second plate 12. The other end of the first supporting piece 3 is foldably connected to one end of the second supporting piece 4. The other end of the second supporting piece 4 is foldably connected to the positioning part 2. In this way, at least one folding line B is formed on the junction of the first supporting piece 3 and the second plate 12, on the junction of the first supporting piece 3 and the second supporting piece 4, and on the junction of the second supporting piece 4 and the positioning part 2. The folding of the above-mentioned junctions is achieved along the at least one folding line B.

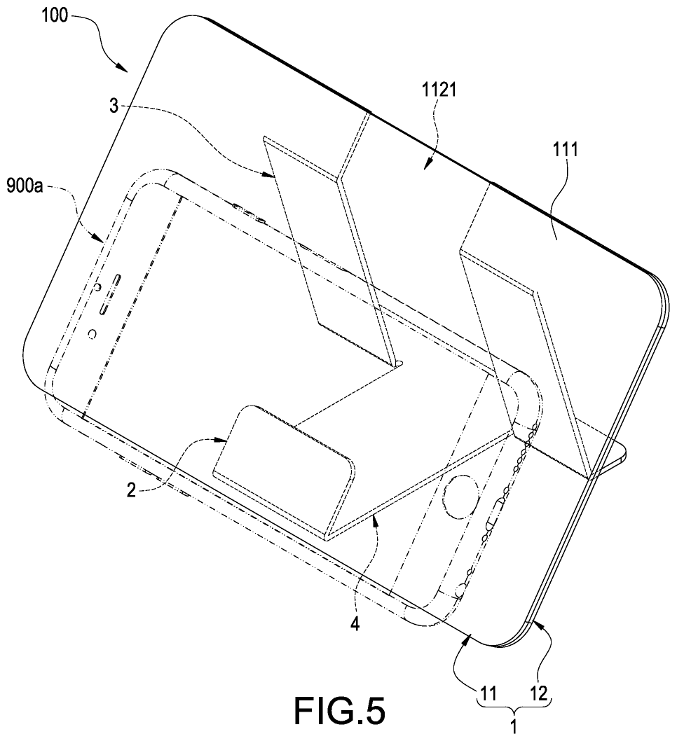

Therefore, as shown in FIG. 4 and FIG. 5, when the user wants to operate an electronic product 900a supported by the support frame 100 with a desired elevation angle, the user may magnetically attach the positioning part 2 to the selected positioning location (e.g., the final positioning location 1121b) corresponding to the desired elevation angle. Then, the first supporting piece 3 and the second supporting piece 4 are folded along each of the folding lines B. After the folding, the plate body 1, the first supporting piece 3, and the second supporting piece 4 are connected to one another in a triangular shape. Consequently, the first supporting piece 3 supports between the plate body 1 and the second supporting piece 4. The second supporting piece 4 supports between the first supporting piece 3 and the positioning part 2. At the same time, the plate body 1 supports between the positioning part 2 and the first supporting piece 3. Thus, the effect of the stable supporting in a triangular configuration through the adjustment to the desired elevation angle is achieved. In this condition, the user may lay the electronic product 900b in close contact with the front side 111 of the first plate 11 of the support frame 100, which further allows the user to operate the electronic product 900a supported on the support frame 100 with the desired elevation angle.

The elevation angle of the support frame 100 of this disclosure may be freely adjusted according to user's needs, which fulfills the requirements of various electronic products supported and used in different use modes in different elevation angles. For instance, those use modes include watching videos, playing mobile games, reading information, browsing web pages, and typing.

In addition, as shown in FIG. 4, it must be noted that the first supporting piece 3 may be a pair of arms 31 and the second supporting piece 4 may include a longitudinal beam 41 a transverse beam 42 connected to each other. One end of the longitudinal beam 41 is connected to the middle portion of an edge of the transverse beam 42 such that the longitudinal beam 41 and transverse beam 42 are together formed into a T-like shape. One end of each of the arms 31 is connected to the inner edge formed on the second plate 12 corresponding to the opening 121. The other end of each of the arms 31 is connected to the rest portion of the above-mentioned edge. The positioning part 2 is connected to the other end of the longitudinal beam 41.

FIG. 6 and FIG. 7 show the support frame 100 of the second embodiment of this disclosure. The second embodiment is similar to the first embodiment. The difference is that the second embodiment further includes a connector 5 and at least one wireless charging module 6.

The connector 5 is electrically connected to the wireless charging module 6, both of which are disposed on the plate body 1. The user may provide power for the wireless charging module 6 by plugging a transmission cable 800 into the connector 5, the wireless charging module 6 may perform wireless charging for the electronic device 900a in close contact with the plate body 1.

Moreover, the plate body 1 further includes a protrusion 1a or protrudes to form a protrusion 1a such that a recess portion 1b is formed on the plate body 1 corresponding to the protrusion 1a. A thick edge 1c is formed on the plate body 1 corresponding to the recess portion 1b. The connector 5 is embedded in the plate body 1 and has a port 51. The port 51 is exposed from the thick edge 1c. The wireless charging module 6 may be disposed solely on the protrusion 1a or disposed solely on the plate body 1 except the protrusion 1a. In this embodiment, two wireless charging modules 6 disposed respectively on the protrusion 1a and on the plate body 1 except the protrusion 1a are used as an example for explanation.

It is worth explaining that the plug (not shown in figures) of the transmission cable 800 may be secured in the recess portion 1b as shown in FIG. 7 to maintain a connection between the transmission cable 800 and the connector 5. Specifically, the connector 5 is clamped between the first plate 11 and the second plate 12.

In this way, one of the two wireless charging modules 6 may perform wireless charging for the electronic device 900a (e.g., the smart mobile phone and the tablet) in close contact with the front side 111 of the plate body 1. The other one of the two wireless charging modules 6 may perform wireless charging for the electronic device 900b (e.g., the smart watch and the smart bracelet) surrounding and hung on the protrusion 1a. It must be noted that the electronic device 900b surrounding and hung on the protrusion 1a may also be supported by the support frame 100 with the desired elevation angle and the user may operate the electronic device 900b in such a situation. In some embodiments, to make the electronic device 900b easily and magnetically attracted by the protrusion 1a, the protrusion 1a may be provided with a magnet part M2 such that the electronic device 900b surrounding and hung on the protrusion 1a may be positioned through the magnetic attraction between the backside of the watch and the front side of the protrusion 1a, which facilitates the wireless charging of the wireless charging module 6.

When the protrusion 1a is not supporting the electronic device 900a, a magnet part M3 may be added. The magnet part M3 may be removably and magnetically attracted on the front side 111 of the plate body 1. A note paper (not shown in figures) may be sandwiched and positioned between the magnet part M3 and the front side 111. Thus, the effect of positioning the note paper is improved. When the magnet part M3 is not used, the magnet part M3 may be temporarily and magnetically attracted on the front side of the protrusion 1a as shown in FIG. 6.

In summary, the support frame with an adjustable elevation angle of this disclosure indeed achieves the expected objectives and overcomes the disadvantages of the related art.

Although this disclosure has been described with reference to the foregoing embodiments, it will be understood that the disclosure is not limited to the details thereof. Various equivalent variations and modifications can still occur to those skilled in this art in view of the teachings of this disclosure. Thus, all such variations and equivalent modifications are also embraced within the scope of this disclosure as defined in the appended claims.

What is claimed is:

1. A support frame with an adjustable elevation angle, the support frame comprising:
a plate body, comprising a plurality of positioning locations;
a positioning part, moveably connected and positioned with one of the positioning locations;
a first supporting piece, connected to the plate body; and
a second supporting piece, connected between the first supporting piece and the positioning part,
wherein the positioning part is connected and positioned with one of the positioning locations according to a predetermined elevation angle, the first supporting piece supports between the plate body and the second supporting piece, the second supporting piece supports between the first supporting piece and the positioning part.

2. The support frame with the adjustable elevation angle according to claim 1, wherein one end of the first supporting piece is foldably connected to the plate body and the other end of the first supporting piece is foldably connected to one end of the second supporting piece, the other end of the second supporting piece is foldably connected to the positioning part.

3. The support frame with the adjustable elevation angle according to claim 2, wherein a folding line is disposed respectively on a junction of the first supporting piece and the plate body, on a junction of the first supporting piece and the second supporting piece, and on a junction of the second supporting piece and the positioning part.

4. The support frame with the adjustable elevation angle according to claim 1, wherein a magnet part and a magnet-attractable part are disposed respectively on the positioning part the plate body, or the magnet part is disposed respectively on the positioning part the plate body.

5. The support frame with the adjustable elevation angle according to claim 4, wherein the positioning part is slidably attached with the plate body to be attracted and positioned with one of the positioning locations.

6. The support frame with the adjustable elevation angle according to claim 5, wherein the plate body, the first supporting piece, and the second supporting piece are connected to one another in a triangular shape.

7. The support frame with the adjustable elevation angle according to claim 1, wherein the plate body comprises a first plate and a second plate connected with each other, the first plate comprises each of the positioning locations, the second plate comprises an opening, each of the positioning locations is exposed through the opening, the positioning part is connected and positioned with one of the positioning locations through the opening.

8. The support frame with the adjustable elevation angle according to claim 1, further comprising: a connector and at least one wireless charging module electrically connected with each other, the connector and the wireless charging module are disposed on the plate body.

9. The support frame with the adjustable elevation angle according to claim 8, wherein the plate body comprises a thick edge, the connector is embedded in the plate body and comprises a port exposed from the thick edge.

10. The support frame with the adjustable elevation angle according to claim 9, wherein the plate body comprises a protrusion and a recess portion corresponding to the protrusion, the wireless charging module is disposed on the protrusion, the thick edge of the plate body is disposed corresponding to the recess portion.

11. The support frame with the adjustable elevation angle according to claim 10, wherein a magnet part is disposed on the protrusion.

12. The support frame with the adjustable elevation angle according to claim 9, wherein two wireless charging modules are disposed, the plate body comprises a protrusion and a recess portion corresponding to the protrusion, one of the wireless charging modules is disposed on the protrusion, the thick edge of the plate body is disposed corresponding to the recess portion.

13. The support frame with the adjustable elevation angle according to claim 12, wherein a magnet part is disposed on the protrusion.
